(19) United States
(12) Patent Application Publication
(10) Pub. No.: US 2025/0367480 A1
(43) Pub. Date: Dec. 4, 2025

(54) HELMET-BASED RESPIRATORY ASSISTANCE DEVICE

(71) Applicant: CLARIVENT MEDICAL INC., Abbotsford (CA)

(72) Inventors: Arpan GROVER, Abbotsford (CA); Vionarica CANNING, Abbotsford (CA)

(21) Appl. No.: 19/221,156

(22) Filed: May 28, 2025

Related U.S. Application Data
(60) Provisional application No. 63/653,574, filed on May 30, 2024.

(51) Int. Cl. A62B 9/02; A42B 3/28; A62B 9/00

(52) U.S. Cl. CPC A62B 9/02; A42B 3/288; A62B 9/006

(57) ABSTRACT

A helmet-based respiratory assistance device is disclosed. The device comprises a hood body with an open end, dimensioned to house a user's head therein, an inflow port and an outflow port flowingly connected to the hood body, and an anti-asphyxiation valve arranged in one of the inflow port and the outflow port. In some embodiments an access port is arranged on the hood body. The access port may comprise a first sealing layer and a second sealing layer attachable to the first sealing layer. The first and second sealing layers are arranged to allow rapid access to the user when the user's head is housed within the hood body.

### CROSS-REFERENCE TO RELATED APPLICATION

This application claims priority from U.S. application No. 63/653,574 filed 30 May 2024 and entitled HELMET-BASED RESPIRATORY ASSISTANCE DEVICE which is hereby incorporated herein by reference for all purposes. This application claims the benefit under 35 U.S.C. § 119 of U.S. application No. 63/653,574 filed 30 May 2024 and entitled HELMET-BASED RESPIRATORY ASSISTANCE DEVICE which is hereby incorporated herein by reference for all purposes.

### FIELD OF THE INVENTION

The invention pertains to devices for providing respiratory assistance to a subject, in particular those in the form of a helmet.

### BACKGROUND

Helmet-based respiratory assistance devices are known in the art. Some conventional respiratory assistance devices include many component parts, resulting in a heavy and bulky device which creates discomfort to the user, and are difficult and expensive to manufacture. The present invention is directed to an improved respiratory assistance device, in particular, improved devices in the form of helmets adapted for housing a user's head.

### SUMMARY

The invention provides a helmet-based respiratory assistance device. The device comprises a hood body with an open end, dimensioned to house a user's head therein, an inflow port flowingly connected to the hood body configured to introduce air into the hood body, and outflow port flowingly connected to the hood body configured to discharge air from the hood body, and an anti-asphyxiation valve arranged at one or both of the inflow port and the outflow ports. The anti-asphyxiation valve comprises a valve housing having an opening for enabling passage of gas, and a sealing member hingedly secured to the valve housing. The sealing member is moveable between a closed configuration and an open configuration. In the closed configuration, the sealing member is moved to cover the opening, allowing a passage of gas into the hood body, thereby pressurizing the hood body. In some embodiments, in the closed configuration, a force of pressure exerts against the sealing member. The force of pressure may maintain the sealing member in the closed configuration. In the open configuration, the sealing member is moved to expose the opening, thereby exposing the hood body to the atmosphere (e.g., to fresh air). In the open configuration, no or minimal pressure is present to exert against the sealing member. The sealing member may be in the open configuration in a relaxed or rest state.

In some embodiments of the invention, two anti-asphyxiation valves are provided. A first anti-asphyxiation valve may be arranged at the inflow port, and a second anti-asphyxiation valve may be arranged at the outflow port. In some embodiments, the first and second anti-asphyxiation valves are positioned diametrically opposed to one another. However, the valves may be positioned at any suitable positions around the hood body.

In some embodiments, an access port is arranged on the hood body, adapted to provide rapid access to the user. The access port may be positioned between the inflow port and the outflow port. In some embodiments, the access port comprises a first sealing layer and a second sealing layer positioned parallel to the first sealing layer along a circumferential axis of the hood body. The first and second sealing layers may be adapted to be moveable between a closed position in which the first and second sealing layers are sealingly engaged with one another, and an open position in which the first and second sealing layers are spaced away from one another. In some embodiments, a top layer may be arranged on top on the first and second layers, engageable with the first and second layers. The top layer may be provided to ensure an airtight seal at the access port. The top layer may comprise a first region and a second region attachable to the first region. The top layer may comprise a mechanical attachment securing the first region to the second region. The detaching of the first and second regions provides access to the first and second sealing layers.

In some example embodiments, the first and second sealing layers are formed of a material comprising one or more elastically flexible polymeric materials. Non-limiting examples of elastically flexible polymeric materials that may be used to form the first and second sealing layers include one or more of thermoplastic elastomer (TPE), thermoplastic polyurethane (TPU), polyvinyl chloride (PVC), silicone, polyethylene terephthalate (PET), Acrylonitrile butadiene styrene (ABS), and other similar polymers.

In some embodiments, a neck seal is arranged to join a perimeter of the open end of the hood body. The neck seal may be dimensioned for sealing to a user's neck when the user's head is housed within the hood body.

In some embodiments, the hood body and the neck seal are formed of a material comprising one or more elastically flexible thermoplastic materials, such as a thermoplastic elastomer (TPE), thermoplastic polyurethane (TPU), polyvinyl chloride (PVC), and combinations thereof.

In some embodiments, a pressure gauge is arranged within a valve housing of the anti-asphyxiation valve. The pressure gauge may comprise a display adapted for displaying a detected pressure level of within the hood body. In some embodiment, the display is exposed on a wall of the valve housing of the anti-asphyxiation valve. The display may comprise pressure level indicators printed on the wall of the valve housing.

In some embodiments, the pressure gauge comprises a housing, a moveable member and a resilient means arranged within the housing, and an air gap defined by a space between a first end of the housing and the moveable member. The moveable member may be adapted to move longitudinally within the housing along a longitudinal axis thereof in response to a pressure within the hood body.

Further aspects of the invention and features of specific embodiments of the invention are described below.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a front elevation view of a respiratory assistance device according to an example embodiment of the invention.

FIG. 2 is a perspective, exploded view, of the FIG. 1 device.

FIG. 3 is a perspective view of an anti-asphyxiation valve according to an example embodiment of the invention.

FIG. 4 is a perspective view of an example top layer arranged to cover the sealing layers of the FIG. 1 device.

FIG. 5A is a perspective view of another example top layer arranged to cover the sealing layers of the FIG. 1 device.

FIG. 5B is a perspective view of the FIG. 5A top layer, illustrating the top layer partially detached from the sealing layers.

FIG. 6A is a cross-sectional view of an anti-asphyxiation valve having a pressure gauge arranged inside the valve according to an example embodiment of the invention.

FIG. 6B is another cross-sectional view of the FIG. 6A anti-asphyxiation valve.

FIG. 6C is a perspective view of the FIG. 6A anti-asphyxiation valve.

### DETAILED DESCRIPTION

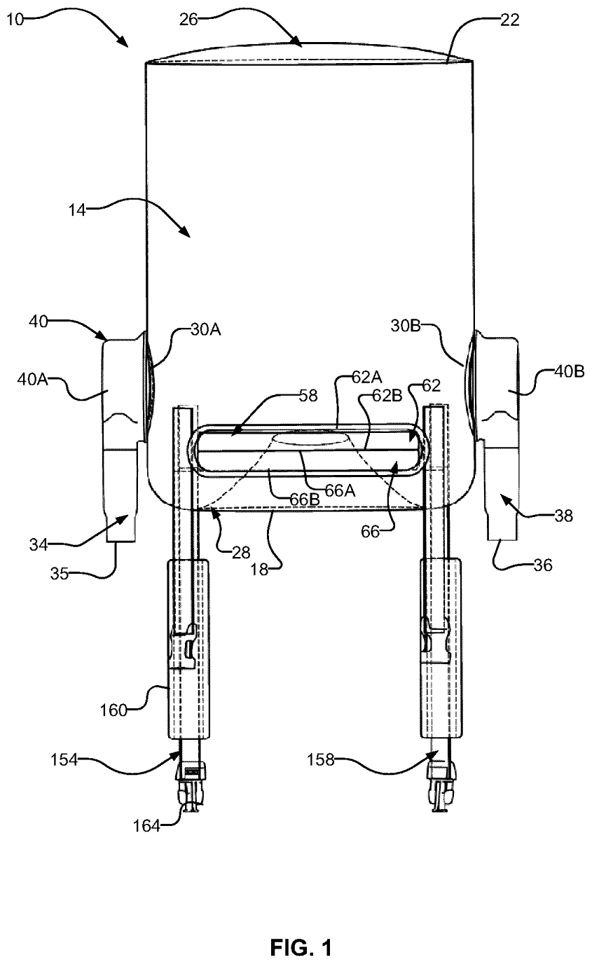

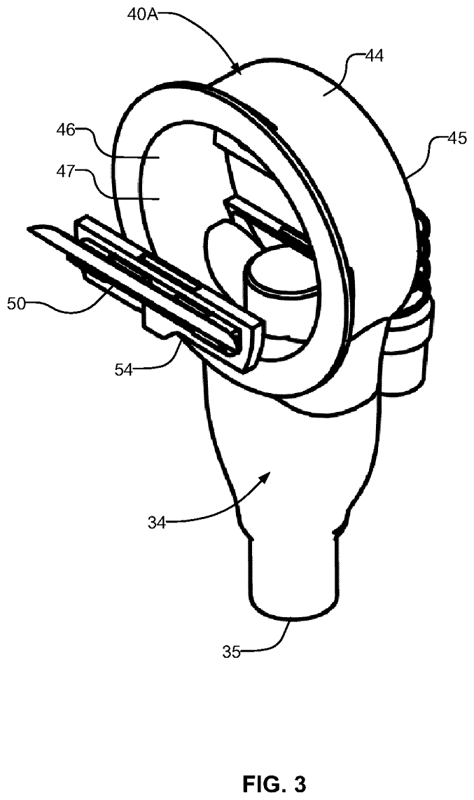

Referring to FIGS. 1 to 6C, in one embodiment, the device of the invention is a helmet-based respiratory assistance device 10. The device 10 may comprise a hood body 14 having an open end 18. The device 10 is dimensioned for housing a user's head therein. The hood body 14 may comprise a generally cylindrical shape. In some embodiments, the hood body 14 comprises two open ends 18, 22. In such embodiments, a roof 26 is bonded to one of the open ends 22. In some embodiments, a neck seal 28 is joined to the perimeter of the open end 18 of the hood body 14. The neck seal 28 is dimensioned to encircle the user's neck, providing an airtight seal when the user's head is housed within the hood body 14.

In some embodiments, the hood body 14 and/or the neck seal 28 is made of a material comprising one or more elastically flexible thermoplastic materials such as a thermoplastic elastomer (TPE), thermoplastic polyurethane (TPU), polyvinyl chloride (PVC), and combinations thereof. In some example embodiments, the one or more elastically flexible thermoplastic materials comprise a thermoplastic elastomer (TPE).

The hood body 14 and the neck seal 28 may both be made of a material comprising a thermoplastic material, so as to allow the hood body 14 and the neck seal 28 to bond with each other without the use of mechanical attachments. Such bonding may include any suitable joining methods to form an airtight seal between the connection of the two components. One such suitable bonding methods comprise heat sealing or heat welding and the like.

In some embodiments, the hood body 14 and the neck seal 28 are made of the same general type of thermoplastic material(s) but of material(s) with different physical properties. In some embodiments, the thermoplastic material(s) selected for forming the hood body 14 has an elastic modulus that is greater than the elastic modulus of the thermoplastic material(s) selected for forming the neck seal 28. In some embodiments, the thermoplastic material(s) selected for forming the hood body 14 has a durometer rating that is greater than the durometer rating of the thermoplastic material(s) selected for forming the neck seal 28. In some embodiments, the durometer rating of the thermoplastic material(s) selected for forming the hood body 14 is at least about 5% to about 30% greater than the durometer rating of the thermoplastic material(s) selected for forming the neck seal 28, and in some embodiments, at least about 5% to at least about 15% greater, and in some embodiments, about 10% to 15% greater. In some embodiments, the durometer rating of the thermoplastic material(s) selected for forming the hood body 14 and/or the neck seal 28 is between about 60 and about 100A, and in some embodiments, between about 75 and about 100A, and in some embodiments, between about 85 to 100A. In some non-limiting examples, the durometer rating of the thermoplastic material(s) selected for forming the hood body 14 is about 92A. In some non-limiting examples, the durometer rating of the thermoplastic material(s) selected for forming the neck seal 28 is about 80A. In some embodiments, thermoplastic material(s) selected for forming the hood body 14 has a thickness that is greater than the thickness of the thermoplastic material(s) selected for forming the neck seal 28.

In some embodiments, the hood body 14 is made of a material that is optically transparent, substantially optically transparent, or at least semi-optically transparent, allowing the user an unobstructed field of vision. In some embodiments, the neck seal 28 is made of a material that is optically transparent, substantially optically transparent, or at least semi-optically transparent.

One or more apertures 30 may be defined on the hood body 14. In some embodiments, at least two apertures 30 are defined on the hood body 14. An inflow port 34 may be arranged to seal a first aperture 30A. An outflow port 38 may be arranged to seal a second aperture 30B. A flow channel 35 is defined by the inflow port 34, and a flow channel 39 is defined by the outflow port 38. In some embodiments, the inflow port 34 is adapted to introduce air through the flow channel 35 into the hood body 14. The outflow port 38 may be adapted to discharge air through the flow channel 39 from the hood body 14. In some example embodiments, the inflow port 34 and the outflow port 38 are arranged diametrically opposed to one another; however, that is not mandatory. The ports 34, 38 may be arranged at any suitable positions around the hood body 14. The number of apertures 30, inflow port 34, and outflow port 38 arranged on the device 10 are not limited to those shown in the drawings. There can be any suitable number of ports 34, 38 arranged on the hood body 14, and in any suitable position(s) thereon.

The device 10 includes at least one anti-asphyxiation valve 40. In some embodiments, the at least one anti-asphyxiation valve 40 is arranged at one or both of the inflow port 34 and the outflow port 38. In some embodiments, the anti-asphyxiation valve 40 is combined with the inflow port 34 or the outflow port 38 to form a single unit. In some embodiments, the inflow port 34 or the outflow port 38 is joined to the anti-asphyxiation valve 40, or otherwise attached, coupled, bonded or welded together to form the single unit. In some embodiments, the inflow port 34 or the outflow port 38 and the anti-asphyxiation valve 40 are injected molded into one single unit.

In some embodiments, two anti-asphyxiation valve 40 are provided. In some embodiments, a first anti-asphyxiation valve 40A and a second anti-asphyxiation valve 40B are arranged diametrically opposed to one another; however this is not mandatory. The valves 40A,40B may be arranged at any suitable positions around the hood body 14. In such embodiments, the first anti-asphyxiation valve 40A and the second anti-asphyxiation valve 40B are arranged to be positioned proximate to each of the ears of the user when the user's head is housed within the hood body 14. In some embodiments, the first anti-asphyxiation valve 40A is arranged at the inflow port 34, and the second anti-asphyxiation valve 40B is arranged at the outflow port 38. Providing two anti-asphyxiation valves 40 on the device 10 has at least the advantages of creating a more reliable suffocation-preventing system such that if one of the valves 40 becomes malfunctional or fails to properly function (for example, when it becomes blocked as a result of the user lying on top of it), then airflow may still be provided through the other valve 40. Providing two anti-asphyxiation valve 40 on the device 10 also allows lighter weight valves 40 to be used, as compared to embodiments in which only one anti-asphyxiation valve 40 is provided. Lighter weight valves 40 advantageously allow for an overall less obstructive device, thereby improving comfort to the user.

In some embodiments, the anti-asphyxiation valve 40 has a valve housing 44 which defines a flow channel 46 with an opening 47 arranged to face the aperture 30 of the hood body 14. In some embodiments, the valve housing 44 comprises a wall 45 opposite to the opening 47. In some embodiments, the flow channel 35, 39 of the port 34, 38 is flowingly connected to the flow channel 46 of the valve housing 44. In some embodiments, the port 34, 38 is arranged proximate to the wall 45 of the valve housing 44. In some embodiments, gas may be caused to flow through the flow channel 35 of the inflow port 34 and then through the flow channel 46 of the valve housing 44 to enter the hood body 14. In some embodiments, gas may be caused to flow out of the hood body 14 through the flow channel 46 of the valve housing 44 and then through the flow channel 39 of the outflow port 38.

A sealing member 50 may be mounted within the valve housing 44. In some embodiments, the sealing member 50 is moveable between a closed configuration and an open configuration within the valve housing 44. In the closed configuration, the sealing member 50 is moved to cover the opening 47 to allow the passage of gas into the hood body 14, thereby pressurizing the hood body 14. In the closed configuration, a force of pressure may be exerted against the sealing member 50 to maintain the sealing member 50 in the closed configuration. In the open configuration, the sealing member 50 is moved to expose the opening 47 to allow the passage of oxygen from the atmosphere (e.g., fresh air) through the flow channel 46 and into the hood body 14. In the open configuration, no or minimal pressure may be present to exert against the sealing member 50. In some embodiments, the sealing member 50 is in the open configuration in a relaxed or rest state. In some embodiments, the port 34, 38 is arranged between the wall 45 of the valve housing 44 and the sealing member 50.

In some embodiments, the inflow port 34 is connectable to a flow source. The flow source may be for example be any suitable source of gas and/or oxygen air supply. For example, the flow source may be hospital wall oxygen, Continuous Positive Airway Pressure (CPAP), Bi-Level Positive Airway Pressure (BiPAP) devices, or ventilators.

The sealing member 50 may be in the open configuration in the relaxed state. In some embodiments, the sealing member 50 is adapted such that the pressure within the hood body 14 at which the sealing member 50 moves from the open configuration to the closed configuration is greater than the pressure within the hood body 14 at which the sealing member 50 moves from the closed configuration to the open configuration. In some embodiments, the pressure within the hood body 14 at which the sealing member 50 is moved from the open configuration to the closed configuration is greater than a predefined pressure level. In some embodiments, such predefined pressure level is in the range of from about 3 cm H₂O (about 0.0427 psi) to about 10 cm H₂O (about 0.142 psi), and in some embodiments, greater than in the range of from about 4 cm H₂O (about 0.057 psi) to about 8 cm H₂O (about 0.114 psi), and in some embodiments, greater than about 5 cm H₂O (about 0.0711 psi). In such embodiments, the sealing member 50 is maintained in the closed configuration when the pressure within the hood body 14 is greater than in the range of from about 3 cm H₂O (about 0.0427 psi) to about 10 cm H₂O (about 0.142 psi), and in some embodiments, greater than in the range of from about 4 cm H₂O (about 0.057 psi) to about 8 cm H₂O (about 0.114 psi), and in some embodiments, greater than about 5 cm H₂O (about 0.0711 psi). In such embodiments, the sealing member 50 is maintained in the open configuration when the pressure within the hood body 14 is less than in the range of from about 3 cm H₂O (about 0.0427 psi) to about 10 cm H₂O (about 0.142 psi), and in some embodiments, less than in the range of from about 4 cm H₂O (about 0.057 psi) to about 8 cm H₂O (about 0.114 psi), and in some embodiments, less than about 5 cm H₂O (about 0.0711 psi).

In some embodiments, the sealing member 50 is hingedly secured to the valve housing 44. In some embodiments, a resilient means 54 is arranged to hingedly secure the sealing member 50 to the valve housing 44. In some example embodiments, such resilient means 54 comprises a spring such as a torsion spring.

In some embodiments, the sealing member 50 comprises a plate. The sealing member 50 comprises any shape suitable for closing the opening 47 of the valve housing 44. In some example embodiments, the sealing member 50 comprises a disc-shape or a half-disc shape.

In some embodiments, an access port 58 is arranged on the hood body 14. The access port 58 may be arranged to allow rapid access to the user when the user's head is housed within the hood body 14. In some embodiments, the access port 58 is arranged between the inflow and outflow ports 34, 38. In some example applications, the access port 58 provides a means to rapidly access a user's mouth, thereby allowing a care provider to feed or provide oral care to the user without requiring removal of the device 10 from the user. The access port may also allow for emergency access and quick intubation.

In some example embodiments, the access port 58 comprises a first sealing layer 62 and a second sealing layer 66. The first and second sealing layers 62, 66 may be arranged to extend longitudinally along a circumferential axis of the hood body 14. The longitudinal lengths of the first and second sealing layers 62, 66 may be identical, or substantially identical so as to provide an airtight seal between the layers 62, 66. The longitudinal lengths of the first and second sealing layers 62, 66 may be adjusted depending on the desired opening size of the access port 58.

In some embodiments, the second sealing layer 66 is oriented parallel to the first sealing layer 66 relative to a circumferential axis of the hood body 14. In some embodiments, the first and second sealing layers 62, 66 are arranged spaced-apart along a longitudinal axis of the hood body 14. In some example embodiments, the first and second sealing layers 62, 66 are moveable between a closed position in which the first and second sealing layers 62, 66 are sealingly engaged with one another, and an open position in which the first and second sealing layers 62, 66 are spaced apart from one another along the longitudinal axis of the hood body 14.

The first and second sealing layers 62, 66 each comprises a respective first longitudinal edge 62A, 66A, and an opposing second longitudinal edge 62B, 66B. In some embodiments, the second longitudinal edge 62B of the first sealing layer 62 is adapted to sealingly engage with the first longitudinal edge 66A of the second sealing layer 66 when the sealing layers 62, 66 are moved to the closed position. In some embodiments, when the sealing layers 62, 66 are moved to the closed position, the first and second sealing layers 62, 66 are each shaped to curve inwardly towards a central longitudinal axis of the hood body 14 as the layer 62, 66 extends from the first longitudinal edge 62A, 66A to the second longitudinal edge 62B, 66B. This may advantageously provide an airtight seal of the edges 62, 66.

In some embodiments, the pressure inside the hood body 14 exerts opposing forces onto the first and second sealing layers 62, 66 to move the sealing layers 62, 66 to the closed position. The opposing forces may comprise a first force exerting on the layers 62, 66 in a first direction towards the first sealing layer 62, and a second force exerting on the layers 62, 66 in a second direction, opposite to the first direction, towards the second sealing layer 66. In some embodiments, the first and second sealing layers 62, 66 are moved to the closed position when the pressure in the hood body 14 reaches a predefined pressure level. Such pressure level may for example be in the range of from about 3 cm H₂O (about 0.0427 psi) to about 10 cm H₂O (about 0.142 psi), and in some embodiments, greater than in the range of from about 4 cm H₂O (about 0.057 psi) to about 8 cm H₂O (about 0.114 psi), and in some embodiments, greater than about 5 cm H₂O (about 0.0711 psi).

In some embodiments, attachment means (not shown) may be arranged on one or both of the first and second sealing layers 62, 66, provided to improve the seal between the layers. Any suitable attachments means may be used. Non-limiting examples include suitable fasteners and adhesives such as a hook and loop fastener, zipper, drawstring fastener, buttons, snaps, etc.

In some embodiments, the first and second sealing layers 62, 66 are made of a material comprising one or more elastically flexible polymeric material such as a thermoplastic elastomer (TPE), thermoplastic polyurethane (TPU), polyvinyl chloride (PVC), and combinations thereof. In some embodiments, the one or more elastically flexible polymeric material comprises a thermoplastic polyurethane (TPU). In some embodiments, the first and second sealing layers 62, 66 are made of silicone elastomer.

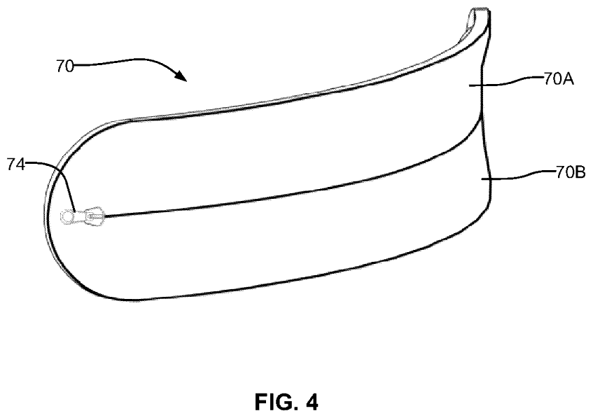

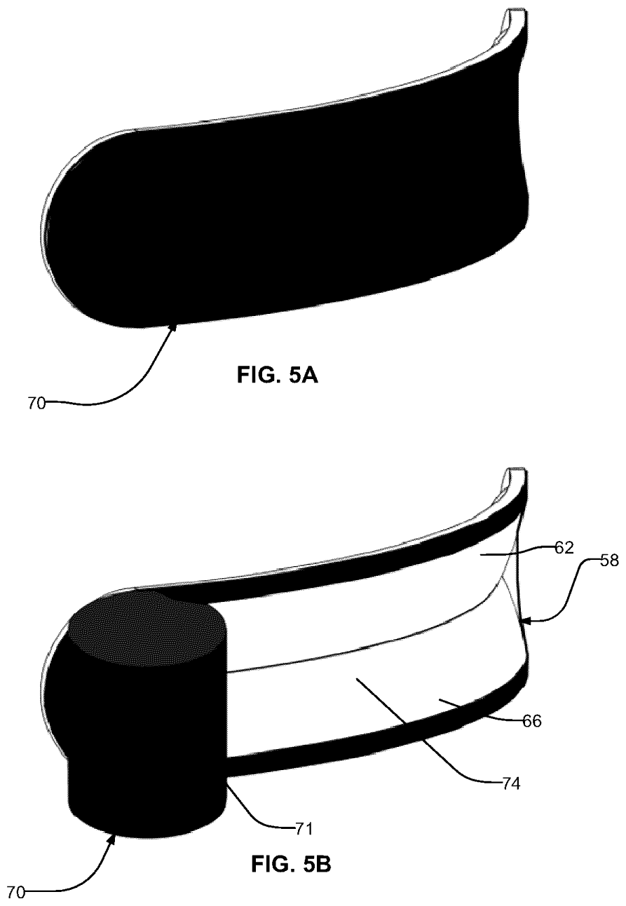

Referring to FIGS. 4, 5A and 5B, in some embodiments, a top layer 70 is arranged on top of the sealing layers 62, 66, dimensioned to engage with at least some portions the sealing layers 62, 66. The top layer 70 may be engageable with the sealing layers 62, 66 The top layer 70 is arranged to ensure closing or sealing of the sealing layers 62, 66 to each other. Referring to the FIG. 4 embodiment, in some embodiments, the top layer 70 comprises a first region 70A attachable to a second region 70B. The first region 70A may be attachable to the second region 70B by a mechanical attachment 74, such as a hook and loop fastener, a zipper, or the like. In some embodiments, the mechanical attachment 74 is arranged at longitudinal edges 62BV, 66A of the first and second sealing layers 62, 66. The separating of the first 70A and second 70B regions of the top layer accesses the sealing engagement of the first and second sealing layers 62, 66 when the layers 62, 66 are sealingly engaged, and/or the opening between the first and second sealing layers 62, 66 when the layers 62, 66 are separated from one another. Referring to the FIGS. 5A and 5B embodiments, in some embodiments, the top layer 70 is arranged to cover the sealing layers 62, 66. The top layer 70 may comprise one layer formed of a material comprising a polymeric material. In some embodiments, the attachment member 74 is arranged on an inner face 71 of the top layer 70. A corresponding attachment member 76 may be aligned on a surface of the sealing layers 62, 66. The top layer 70 may be connectable to the sealing layers 62, 66 by contacting the attachment members 74, 76.

In some embodiments, the hood body 14 and the sealing layers 62, 66 are made of a material comprising a polymeric material. In some embodiments, the hood body 14 and the sealing layers 62, 66 are made of a material consisting of one or more polymeric materials. This allows the hood body 14 and the sealing layers 62, 66 to bond with one another without the use of mechanical attachments. Such bonding may include any suitable joining methods to form an airtight seal between the components. One such suitable bonding methods comprise heat sealing or heat welding and the like.

In some embodiments, the polymeric material(s) selected for forming the sealing layers 62, 66 has an elastic modulus that is greater than the elastic modulus of the polymeric material(s) selected for forming the hood body 14. In some embodiments, the polymeric material(s) selected for forming the sealing layers 62, 66 has a durometer rating that is greater than the durometer rating of the polymeric material(s) selected for forming the hood body 14.

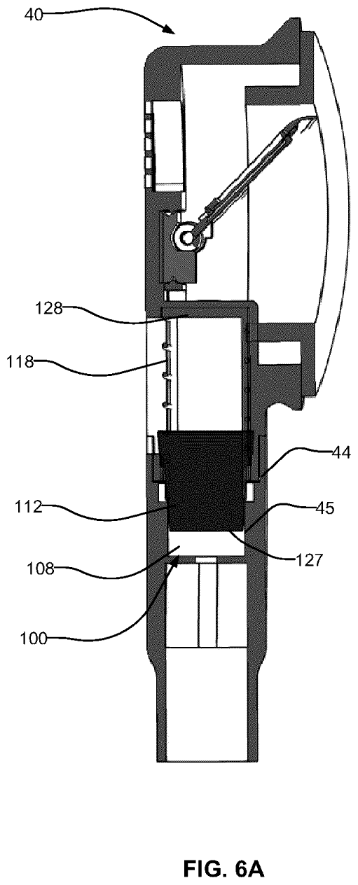

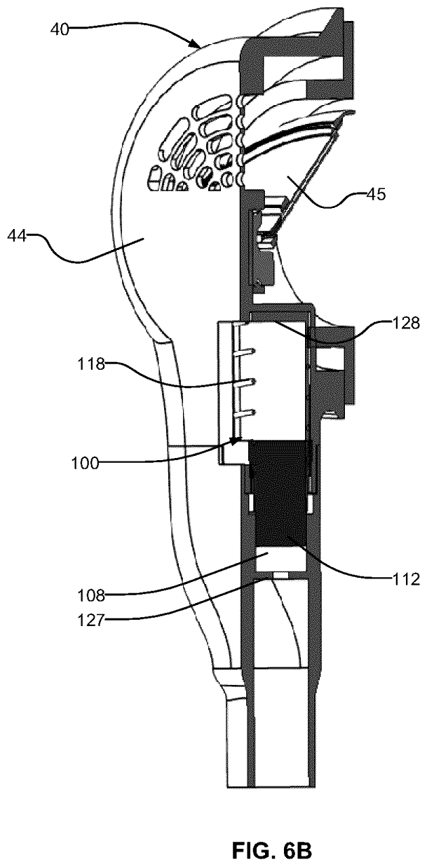

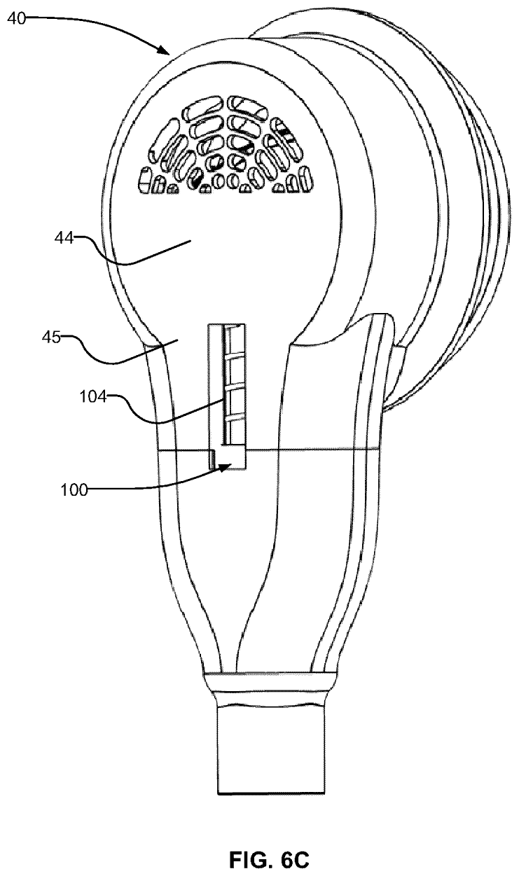

Referring to FIGS. 6A to 6C, in some embodiments, a pressure gauge (or manometer) 100 is arranged within the anti-asphyxiation valve 40, to detect a pressure within the hood body 14. The pressure gauge 100 may be positioned proximate to the wall 45 of the valve housing 44. In some embodiments, a display 104 configured to show a detected pressure level of an inside of the hood body 14 is arranged on the wall 45 of the valve housing 44. In some embodiments, pressure level indicators are printed on the wall 45 proximate to the display 104.

In some embodiments, the manometer 100 comprises a housing 108. A moveable member 112 and a resilient means 118 may be arranged within the housing 108. The moveable member 112 may be adapted to move longitudinally within the housing 108, relative to a longitudinal axis thereof. The resilient means 118 are arranged to exert resistance to the moveable member 112 as the member 112 moves in the direction from a first end 127 towards an opposing second end 128 of the housing 108. The moveable member 112 may be adapted to move longitudinally within the housing 108 in response to pressure detected from within the hood body 14. The amount of longitudinal movement of the moveable member 112 within the housing 108, in particular in the direction towards the second end 128 of the housing, correlates with the amount of pressure detected from within the hood body 14. The resilient means 118 may be pre-calibrated. The pre-calibration may comprise calibrating the resilient means 118 to exert desired levels of resistance against the moveable member 112 in response to each tested pressure level.

In some embodiments, the moveable member 112 is made of a rubber material. In some embodiments, the rubber material comprises silicone.

In some embodiments, the resilient means 118 comprises a spring.

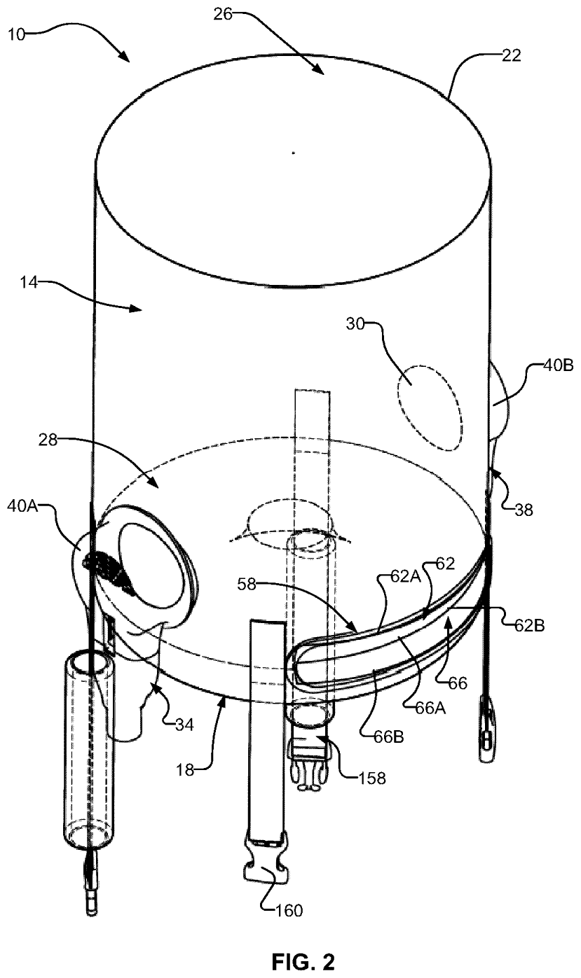

Referring to FIGS. 1 and 2, the device 10 may comprise two or more straps 154, 158. The two or more straps 154, 158 may be secured to the hood body 14, adapted for securing the device 10 to a body of the user, and/or to surrounding fixtures such as the frame of a hospital bed. In some embodiments, the straps 154, 158 are designed to wrap under the arms of the user. The straps 154, 158 may assist in maintaining the hood body 12 in the desired position, by resisting a vertically upward movement of the device 10 as a result of high pressures in the hood body 12. The straps 154, 158 may assist to prevent or minimize the unwanted upward force.

In some embodiments, the two or more straps 154, 158 each comprises an underarm pad 160 positioned to facilitate comfort to the user. In some embodiments, the straps 154, 158 are made of a nylon material, or the like.

In some embodiments, the two or more straps 154, 158 are connectable by a fastener means 160. In some example embodiments, the fastener means 164 comprise a quick release buckle. The quick release buckle is arranged to provide easy donning and doffing.

In some embodiments, two straps 154, 158 are secured to the hood body 14. In such embodiments, the two straps 154, 158 are positioned diametrically opposed to one another. The straps 154, 158 may be positioned at other suitable positions on the hood body 14. In some embodiments, one strap, or more than two straps are secured to the hood body 14.

The respiratory assistance device 10 may be used to perform one or more functions. In some non-limiting examples, the respiratory assistance device 10 is used to deliver positive pressure ventilation to a subject non-invasively, by NIPPV. In some non-limiting examples, the respiratory assistance device 10 is used to deliver oxygen to a subject. In some non-limiting examples, the respiratory assistance device 10 is used to introduce a continuous positive airway pressure (CPAP) to a subject.

Throughout the foregoing description and the drawings, in which corresponding and like parts are identified by the same reference characters, specific details have been set forth in order to provide a more thorough understanding to persons skilled in the art. However, well known elements may not have been shown or described in detail or at all to avoid unnecessarily obscuring the disclosure.

As will be apparent to those skilled in the art in the light of the foregoing disclosure, many alterations and modifications are possible in the practice of this invention without departing from the scope thereof. Accordingly, the description and drawings are to be regarded in an illustrative, rather than a restrictive, sense.

1. A helmet-based respiratory assistance device (10), comprising:
a hood body (14) having one open end (18), the hood body being dimensioned for housing a user's head therein;
an inflow port (34) flowingly connected to the hood body configured to introduce air into the hood body;
an outflow port (38) flowingly connected to the hood body configured to discharge air from the hood body; and
an anti-asphyxiation valve (40) is arranged at one of the inflow port and the outflow port, the anti-asphyxiation valve comprising a valve housing (44) having an opening (47) for enabling passage of gas, and a sealing member (50) hingedly secured to the valve housing, the sealing member being moveable between a closed configuration in which the sealing member is moved to cover the opening to allow a passage of gas into the hood body, and an open configuration in which the sealing member is positioned to expose the hood body to an atmosphere,
wherein the sealing member is in the open configuration in a rest state.

2. The device according to claim 1, wherein the sealing member is configured such that the pressure within the hood body at which the sealing member moves from the open configuration to the closed configuration is greater than the pressure within the hood body at which the sealing member moves from the closed configuration to the open configuration.

3. The device of according to claim 1, wherein the sealing member is moved into the closed configuration when the pressure within the hood body is at a predefined level, or greater than the predefined level.

4. The device according to claim 1, wherein the device comprises a first anti-asphyxiation valve (40A) and a second anti-asphyxiation valve (40B), the first anti-asphyxiation valve being arranged at the inflow port, and the second asphyxiation valve being arranged at the outflow port.

5. The device according to claim 1, wherein the sealing member is in the form of a plate.

6. The device according to claim 1, further comprising a resilient means (54) arranged to hingedly secure the sealing member to the valve body.

7. The device according to claim 6, wherein the resilient means comprises a spring.

8. The device according to claim 1, further comprising an access port (58) arranged on the hood body between the inflow and outflow ports.

9. The device according to claim 8, wherein the access port comprises a first sealing layer (62) and a second sealing layer (66) sealingly engageable with the first sealing layer.

10. The device according to claim 9, wherein the first and second sealing layers are arranged to extend longitudinally along a circumferential axis of the hood body, and are arranged spaced-apart relative to a longitudinal axis of the hood body.

11. The device according to claim 10, wherein the first and second sealing layers are moveable between closed position in which the first and second sealing layers are sealingly engaged with one another, and an open position in which the first and second sealing layers are spaced-apart from one another along the longitudinal axis of the hood body.

12. The device according to claim 11, wherein the first and second sealing members are shaped to curve inwardly towards a central longitudinal axis of the hood body in the closed position.

13. The device according to claim 9, wherein the first and second sealing members are made of a material comprising one or more elastically flexible polymeric materials.

14. The device according to claim 9, wherein the first and second sealing members are made of a silicone elastomer.

15. The device according to claim 9, wherein the access port further comprises a top layer engageable with the first and second sealing layers.

16. The device according to claim 15, wherein the top layer comprises a first region, a second region attachable to the first region, and a mechanical attachment secured to longitudinal edges (62B, 66A) of the first and second regions.

17. The device according to claim 1, further comprising a pressure gauge (100) mounted within the valve housing of the anti-asphyxiation valve.

18. The device according to claim 17, wherein the pressure gauge comprises a display (104) adapted for displaying a detected pressure level of within the hood body, wherein the display is exposed on a wall (45) of the valve housing of the anti-asphyxiation valve.

19. The device according to claim 18, wherein the display comprises pressure level indicators provided on the wall of the valve housing of the anti-asphyxiation valve proximate to the display.
